(19) United States
(12) Patent Application Publication
(10) Pub. No.: US 2018/0368587 A1
(43) Pub. Date: Dec. 27, 2018

(54) PORTABLE PRIVACY BABY CHANGING PAD

(71) Applicants: Diana Trieu, Rosemead, CA (US); Hong Thi Nguyen, Lakewood, CA (US)

(72) Inventors: Diana Trieu, Rosemead, CA (US); Hong Thi Nguyen, Lakewood, CA (US)

(21) Appl. No.: 16/004,667

(22) Filed: Jun. 11, 2018

Related U.S. Application Data
(60) Provisional application No. 62/523,415, filed on Jun. 22, 2017.

(51) Int. Cl. A47D 5/00; E06B 9/24; A47D 15/00

(52) U.S. Cl. CPC A47D 5/006; A47D 15/005; E06B 9/24

(57) ABSTRACT

A baby changing apparatus. The baby changing apparatus includes a pad having an upper surface, a lower surface, a first side and a second side. A first connector is disposed on the first side. A privacy shield includes a proximal end joined to and extending from the first side of the pad and a distal end. A second connector is coupled to the distal end. The privacy shield is configured to fold over itself and the pad such that the second connector releasably connects to the first connector and the privacy shield forms a tube shape in a deployed position.

### CROSS-REFERENCE TO RELATED APPLICATION

This application claims the benefit of priority of U.S. provisional application No. 62/523,415, filed Jun. 22, 2017, the contents of which are herein incorporated by reference.

### BACKGROUND OF THE INVENTION

The present invention relates to changing diapers and, more particularly, to a portable privacy baby changing pad.

The exposure of a baby's bottom and soiled diaper from changing the baby when away from home can be uncomfortable both for the caregiver and surrounding people. A private area may not be readily available to change a baby's diaper, such as a baby changing station, or going back to the car. Portable changing pads do exist, but none provides a privacy component for baby, caregiver and the public.

As can be seen, there is a need for a portable privacy baby changing pad.

### SUMMARY OF THE INVENTION

In one aspect of the present invention, a baby changing apparatus comprises: a pad comprising an upper surface, a lower surface, a first side, and a second side, and a first connector disposed at the second side; a privacy shield comprising a proximal end joined to and extending from the first side of the pad, a distal end, and a second connector coupled to the distal end, wherein the privacy shield is configured to fold over itself and the pad such that the second connector releasably connects to the first connector and the privacy shield forms a tube shape in a deployed position.

These and other features, aspects and advantages of the present invention will become better understood with reference to the following drawings, description and claims.

### BRIEF DESCRIPTION OF THE DRAWINGS

FIG. 1 is a perspective view of an embodiment of the present invention in use;

FIG. 2 is a top plan view of an embodiment of the present invention; FIG. 3 is a right-side elevation view of an embodiment of the present invention;

FIG. 4 is a top plan view of an embodiment of the present invention in a folded out configuration;

FIG. 5 is a perspective view of an embodiment of the present invention in a stowed configuration; and

FIG. 6 is an exploded perspective view of an embodiment of the privacy shield of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The present invention includes a portable privacy baby changing pad. The present invention provides a portable baby changing pad with a privacy shield that limits the exposure and visibility of the baby's bottom half and soiled diaper, while allowing the caregiver to change the baby's diaper with consideration for public common courtesy.

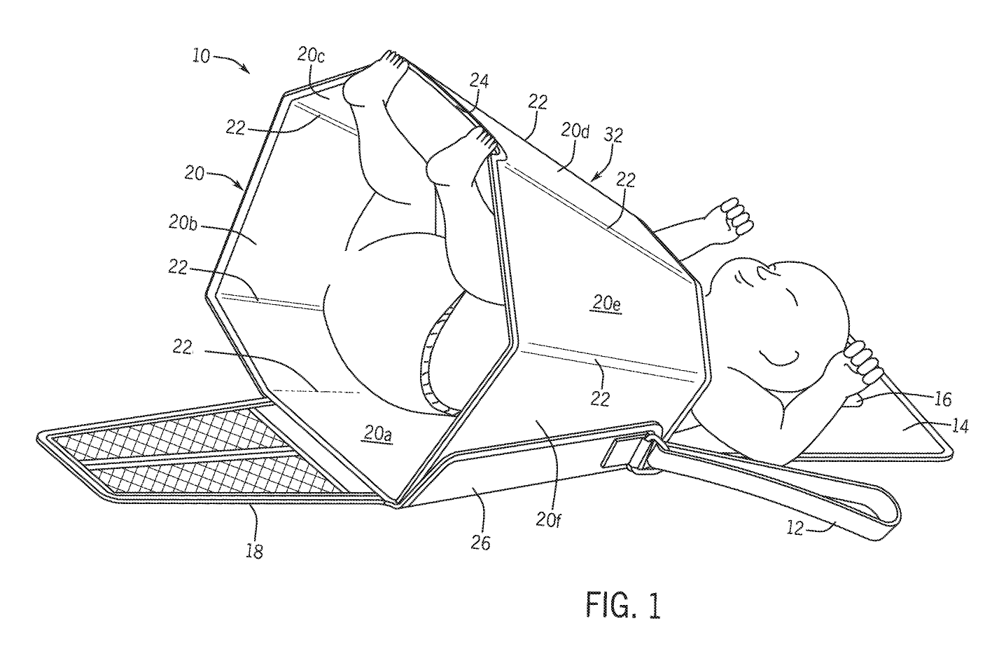

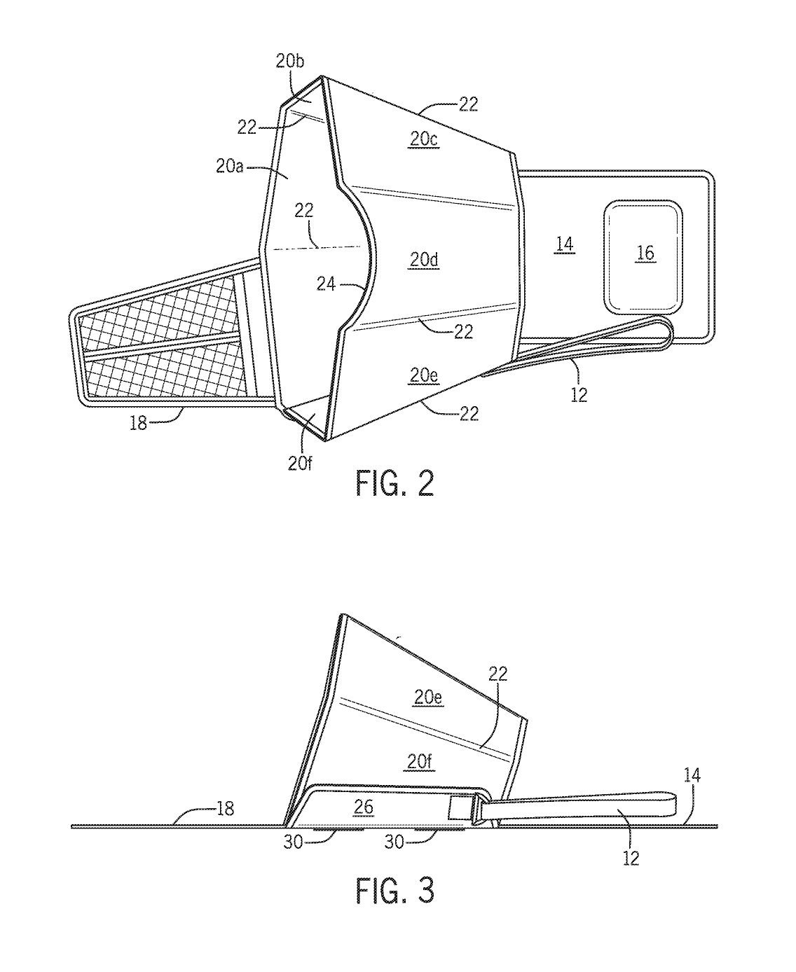

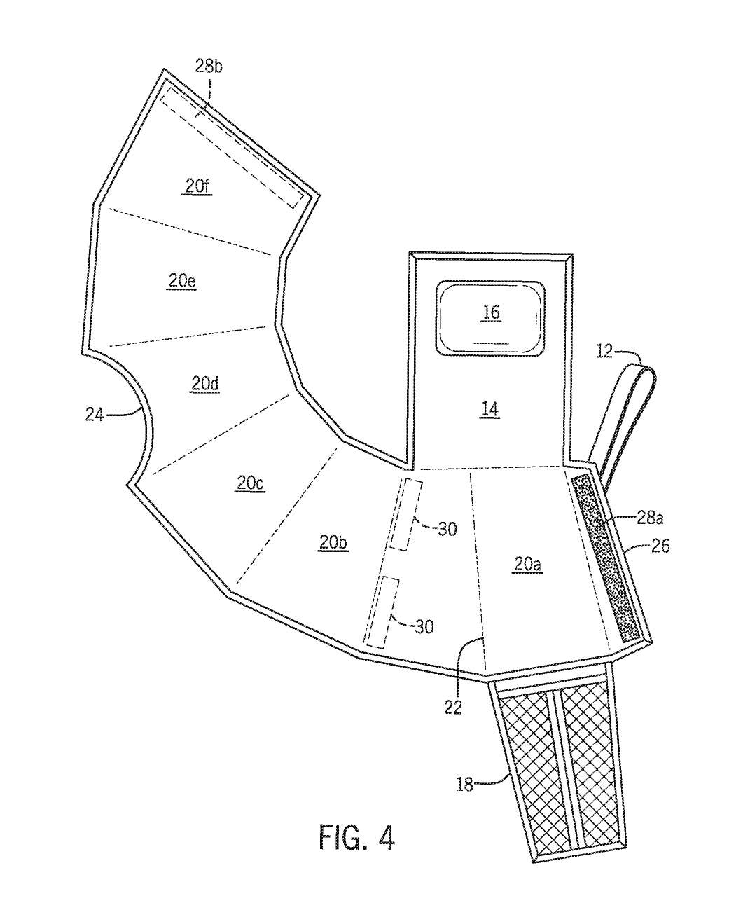

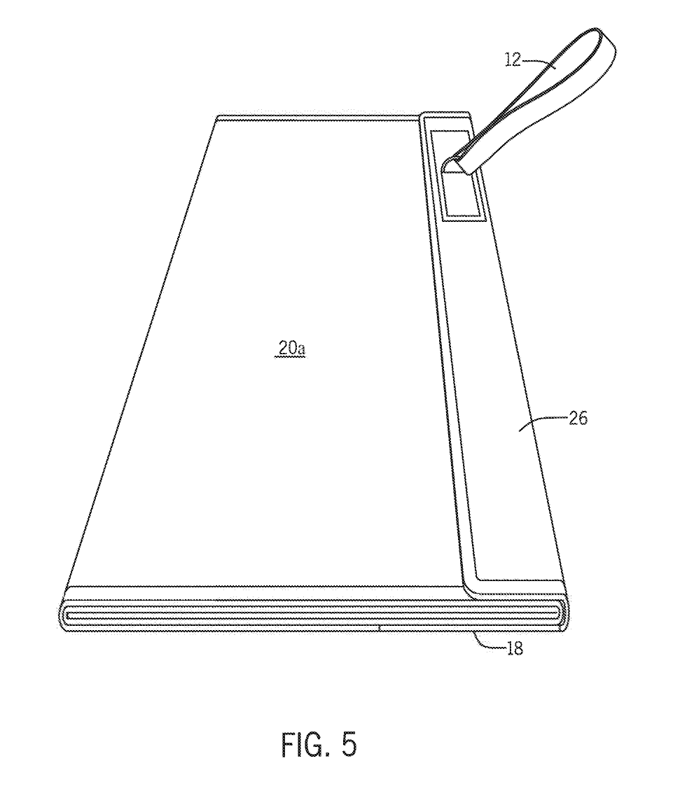

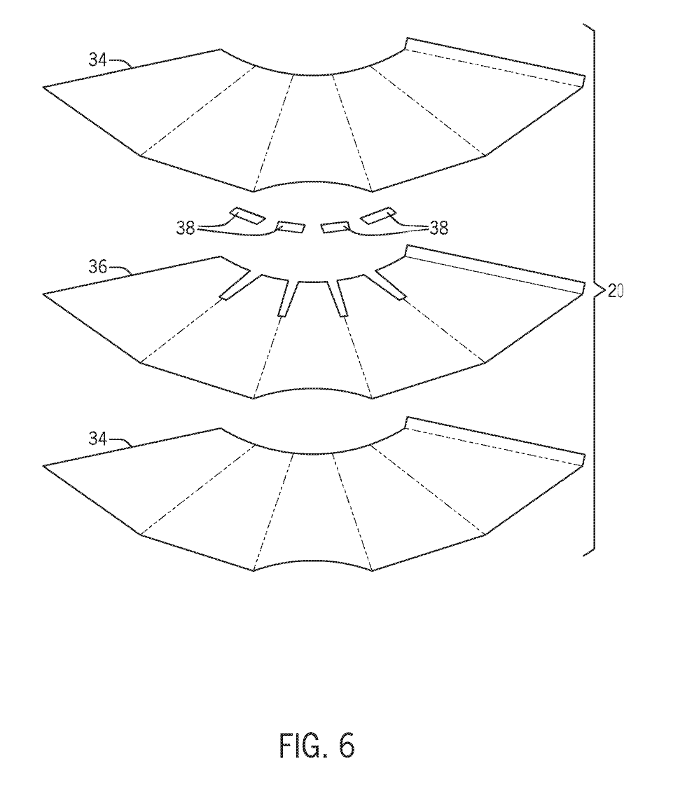

Referring to FIGS. 1 through 6, the present invention includes a baby changing apparatus 10. The baby changing apparatus 10 includes a pad 14 having an upper surface, a lower surface, a first side and a second side. A first connector 28a is disposed on the first side. A privacy shield 20 includes a proximal end joined to and extending from the first side of the pad 14 and a distal end. A second connector 28b is coupled to the distal end. The privacy shield 20 is configured to fold over itself and a bottom side of the pad 14 such that the second connector 28b releasably connects to the first connector 28a and the privacy shield 20 forms a tube shape in a deployed position.

The privacy shield 20 may be made of a plurality of panels 20a-20f joined by seams 22. The plurality of panels 20a-20f may include a base panel 20a, a first side panel 20b, a second side panel 20c, a central panel 20d, a third side panel 20e, and an end panel 20f. The base panel 20a is joined to and extends from a bottom end of the pad 14. A closure flap 26 may extend laterally from the base panel 20a. The first connector 28a may be coupled to an upper surface of the closure flap 26. The panels 20a-20f may be constructed of a stabilizer internal layer 36 with a light weight fabric 34 external layer. The panels 20a-20f may each further include an inner edge and an outer edge. Elastic members 38 may join the panels 20a-20f at the inner edges.

In certain embodiments, the tube shape of the deployed position is a frusto conical shape. The frusto conical shape widens at the end, thereby allowing the user more space to access the baby's diapers. In certain embodiments, the central panel 20d of the plurality of panels includes a semi-circular cutout portion 24 formed along the outer edge. The semi-circular cutout portion 24 also provides additional space and provides visual clearance. The semi-flexibility of the invention allows for the frusto conical structure fluidity for maneuvering baby or toddler while changing the diaper and for visibility.

In certain embodiments, a third connector 30 connector is coupled to an underside of the base panel 20a. The panels 20a-20f may fold about their seams to a stowed position. The third connector 30 releasably attaches to the second connector 28a in the stowed position.

The connectors 28a, 28b, 30 of the present invention may include hook and loop fasteners, magnets, snap buttons, straps, ties, hooks, clips and the like.

The present invention may further include additional accessories. A pillow 16 may be joined to and extending from the upper surface of the pad 14, providing additional padding for the baby's head. An accessory pouch 18 may extend from a bottom edge of the base panel 20a. The accessory pouch 18 may store additional diapers and wipes. A carrying strap 12 may be joined to and extending from the base panel 20a, allowing users to easily carry the baby changing apparatus 10.

A method of using the present invention may include the following steps. When a baby or toddler needs to be changed, the caretaker may unfold the baby changing apparatus 10, place the baby or toddler on the pad 14, fold the privacy shield 20 over the baby or toddler, and connect the privacy shield 20 in the deployed position. The privacy shield 20 creates a tube-like structure, providing the privacy component while changing a diaper.

It should be understood, of course, that the foregoing relates to exemplary embodiments of the invention and that modifications may be made without departing from the spirit and scope of the invention as set forth in the following claims.

What is claimed is:

1. A baby changing apparatus comprising:
a pad comprising an upper surface, a lower surface, a first side, and a second side, and a first connector disposed at the second side;
a privacy shield comprising a proximal end joined to and extending from the first side of the pad, a distal end, and a second connector coupled to the distal end, wherein
the privacy shield is configured to fold over itself and the pad such that the second connector releasably connects to the first connector and the privacy shield forms a tube shape in a deployed position.

2. The baby changing apparatus of claim 1, wherein the tube shape is a frusto conical shape.

3. The baby changing apparatus of claim 1, wherein the privacy shield is made of a plurality of panels that are joined by seams, wherein the privacy shield folds about the seams in a stowed position.

4. The baby changing apparatus of claim 3, wherein a base panel of the plurality of panels is joined to and extending from a bottom end of the pad.

5. The baby changing apparatus of claim 4, wherein the first connector is coupled to the base panel.

6. The baby changing apparatus of claim 4, further comprising an accessory pouch extending from an outer edge of the base panel.

7. The baby changing apparatus of claim 3, further comprising a third connector coupled to a bottom surface of the base panel, wherein the second connector releasably connects to the third connector in the stowed position.

8. The baby changing apparatus of claim 3, wherein a central panel of the plurality of panels comprises a semi-circular cutout portion formed along a bottom edge.

9. The baby changing apparatus of claim 1, further comprising a pillow joined to and extending from the upper surface of the pad.

10. The baby changing apparatus of claim 4, further comprising a carrying strap joined to and extending form the base panel.
